(19) United States
(12) Patent Application Publication
(10) Pub. No.: US 2020/0367245 A1
(43) Pub. Date: Nov. 19, 2020

(54) Mesh Link-Aware DFS

(71) Applicant: Parallel Wireless, Inc., Nashua, NH (US)

(72) Inventor: Louis Arthur Paquette, Temple, NH (US)

(21) Appl. No.: 16/876,576

(22) Filed: May 18, 2020

Related U.S. Application Data
(60) Provisional application No. 62/849,500, filed on May 17, 2019.

(51) Int. Cl. H04W 72/04; H04W 16/14; H04W 84/18; H04W 24/02; H04W 24/04

(52) U.S. Cl. CPC H04W 72/0453; H04W 16/14; H04W 24/04; H04W 24/02; H04W 84/18

(57) ABSTRACT

A method, system and computer readable medium is described for mesh link-aware dynamic frequency selection (DFS). In one embodiment the method includes determining, in a mesh network having a plurality of mesh nodes and mesh links interconnecting the mesh nodes, a DFS event has been generated by a radar source interfering with a mesh link; refraining from using the mesh link in order to prevent interfering with the DFS event; and rerouting mesh messages which would have used the mesh link through other mesh nodes and links.

### CROSS-REFERENCE TO RELATED APPLICATIONS

This application claims priority under 35 U.S.C. § 119(e) to U.S. Provisional Pat. App. No. 62/849,500, filed May 17, 2019, titled “Mesh Link-Aware DFS” which is hereby incorporated by reference in its entirety for all purposes. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

In radio communications, spectrum is a scarce resource. Often, there can be more than one non-interworking users for a particular channel or frequency. In general, in such a case one of those users is designated as the primary user and the other as the secondary user. The secondary user of a frequency would have additional constraints defined for its operation including regulations for power and constraints put on the spectral emission mask. The primary goal of all these restrictions is to allow the secondary users access to the spectrum as long as they do not interfere with the operation of the primary user.

The 5 GHz spectrum is typically put to three distinct primary uses: maritime communications radars; weather radars; and military communications. The interesting thing about these users is that even though they are the primary users of a large chunk of spectrum, they use it very sporadically and typically require very low bandwidths. So, in order to make best use of this underutilized spectrum, regulatory authorities in the European Union have developed a concept called dynamic frequency selection (DFS). The DFS regulations impose very strict timing and non-interference requirements on the secondary users of the spectrum, which also make the spectrum useful only in an unlicensed/lightly-licensed scenario. Over the years, the use of DFS has spread throughout the world. It has been one of the major drivers for adoption of Wi-Fi as DFS provides it with a huge spectrum which is lot less noisy than the 2.4 GHz ISM band.

Each regulatory regime has defined pulse patterns for radars, which a secondary user is expected to detect in real time and take corrective action so as to not interfere with them.

In a typical mesh network of base stations (mesh network nodes and mesh gateway nodes), the mesh links are used to communicate between mesh nodes.

### SUMMARY

In some embodiments, a DFS event is generated by a radar source that interferes with a mesh link. The mesh link affected by the DFS event is no longer used by the mesh network so as to not interfere with the DFS event. Mesh messages which would have otherwise used the mesh link are rerouted through other mesh nodes and links.

### BRIEF DESCRIPTION OF THE DRAWINGS

FIG. 1 depicts a network diagram of a wireless network, in accordance with some embodiments.

FIG. 2 is a schematic diagram of a coordinating gateway, in accordance with some embodiments.

FIG. 3 is a schematic diagram of an enhanced base station, in accordance with some embodiments.

### DETAILED DESCRIPTION

The detailed description set forth below is intended as a description of various configurations of the subject matter and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details. In some instances, well-known structures and components are shown in block diagram form in order to avoid obscuring the concept of the subject technology.

Overview

It is possible to use multiple forms of backhaul to connect to a core network from a base station, including wired, LTE, microwave, satellite, etc. For example, in the Parallel Wireless architecture, in the 3G architecture, and in recent proposed versions of the 5G architecture, a base station communicates with a coordinating node located between the radio access network (RAN) and the core network. In the situation where a base station uses a wireless backhaul link, communications from the base station to the coordinating node may flow through a secured tunnel through the intermediary nodes before reaching the coordinating node and entering into an unencrypted core network environment. For wireless backhaul using Long Term Evolution (LTE), the base station may have an onboard LTE modem, in some embodiments, which can attach to an existing LTE network and provide IP connectivity.

It is also possible to use a mesh network to connect to a core network from a base station to provide backhaul. A mesh network includes several mesh nodes, which flexibly route traffic to an appropriate point of egress for the traffic; benefits of a mesh network include resiliency, since any failures can be routed around, and congestion tolerance, as congestion is tolerated as is any other failure. However, mesh networks typically have a few nodes that are connected more directly to the core network or with more robust, higher throughput, or higher availability backhaul links to the core network, and these nodes, called mesh gateway nodes, can become overwhelmed when they provide backhaul capability to a large number of mesh nodes. For example, if each mesh node is providing wireless connectivity/access to a handful of mobile devices, any one mesh node can be backhauled by a mesh gateway node without issue, but the mesh gateway node may become congested when a large number of mesh nodes is backhauled by a single mesh gateway node. The mesh network may include one or more wireless links.

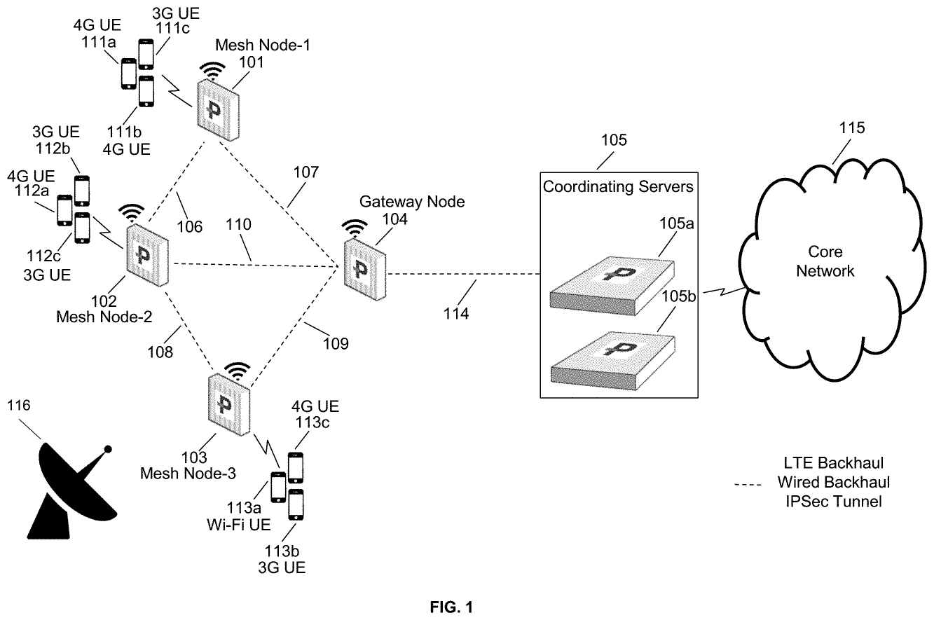

Dynamic frequency selection (DFS) management is a complicated process in radio access networks (RANs), and especially in mesh networks. FIG. 1 depicts a network diagram of a wireless network, in accordance with some embodiments. In some embodiments, as shown in FIG. 1, a mesh node-1 101, a mesh node-2 102, a mesh node-3 103 are base stations. The Base stations 101, 102, and 103 form a mesh network establishing mesh network link 106, 107, 108, 109, and 110 with a base station 104. The base station 104 acts as gateway node or mesh gateway node, and provides backhaul connectivity to a core network to the base stations 101, 102, and 103 over backhaul link 114 to a coordinating server(s) 105. The Base stations 101, 102, 103, 104 may also be known by other names such as eNodeB, NodeB, Access Point, Femto Base Station etc. and may support radio access technologies such as 2G, 3G, 4G, 5G, Wi-Fi etc. The coordinating servers 105 is shown with two coordinating servers 105a and 105b. The coordinating servers 105a and 105b may be in load-sharing mode or may be in active-standby mode for high availability. The coordinating servers 105 may be located between a radio access network (RAN) and the core network and may appear as core network to the base stations in a radio access network (RAN) and a single eNodeB to the core network. As shown in the FIG. 1, various user equipments 111a, 111b, 111c are connected to the base station 101. The base station 101 provides backhaul connectivity to the user equipments 111a, 111b, and 111c connected to it over mesh network links 106, 107, 108, 109, 110 and 114. The user equipments may also be known by other names such as mobile devices, mobile phones, personal digital assistant (PDA), tablet, laptop etc. The base station 102 provides backhaul connection to user equipments 112a, 112b, 112c and the base station 103 provides backhaul connection to user equipments 113a, 113b, and 113c. The user equipments 111a, 111b, 111c, 112a, 112b, 112c, 113a, 113b, 113c may support any radio access technology such as 2G, 3G, 4G, 5G, Wi-Fi, WiMAX, LTE, LTE-Advanced etc.

Radar source 116 may generate sporadic radar interference in the 5 GHz band, in some embodiments, affecting all the 5 GHz radio links in the network.

In operation, when a DFS event is generated by radar source 116 that affects one of the mesh links, the mesh link is no longer used by the mesh nodes and the messages intended from one mesh node to another mesh node that would have otherwise used the mesh link are routed through other mesh nodes so as to not interfere with the DFS event.

In a particular example, radar unit 116 generates a DFS event. Mesh link 108 is affected by the DFS event. Accordingly, mesh link 108 is no longer used by mesh node 103 or 102. Any messages between mesh nodes 102 and 103 are rerouted, for example by using mesh links 109 and 110 and gateway node 104.

In some embodiments, if one link goes down, all mesh links may be subject to recalculation. This recalculation may be determined by the HNG as well as or alternatively via peer-to-peer (mesh node to mesh node) negotiation. In some embodiments mesh nodes can send a message to other mesh nodes alerting them to the DFS condition and requesting these various actions to be taken.

While the examples used herein utilize a mesh network, it should be appreciated that this methodology can be used with non-mesh situations such as wireless backhaul (this is essentially a 2-node mesh); in other words, DFS can be taken into account for scheduling drops in backhaul. The methods may apply to LTE-compatible networks, to UMTS-compatible networks, 5G networks, or to networks for additional protocols that utilize radio frequency data transmission.

Certain hardware that may be used in some embodiments of the disclosure are now described.

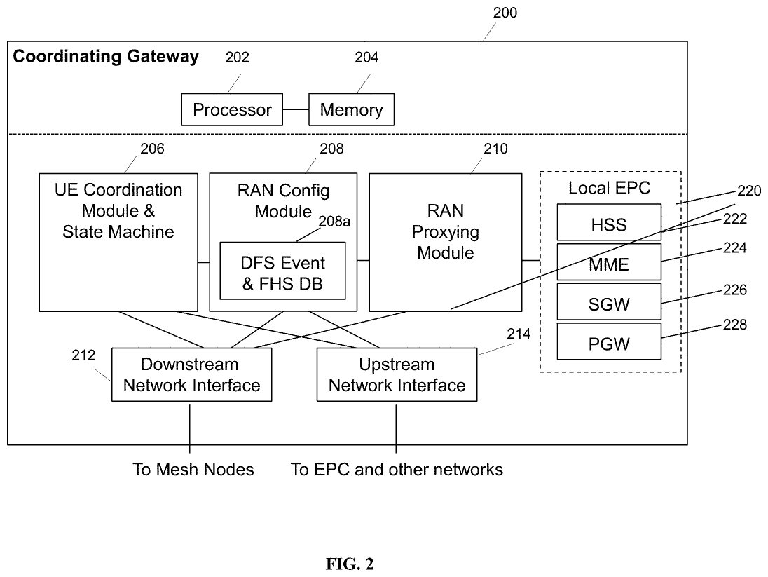

FIG. 2 is a schematic diagram of a coordination node, in accordance with some embodiments. Coordination node/gateway 200 includes processor 202 and memory 204, which are configured to provide the functions described herein. Also present are UE coordination module and state machine 206, radio access network (RAN) configuration module 208, and radio access network proxying module 210. UE module 206 may use a state machine to determine how to virtualize messages to or from the UE at the coordinating node. UE module 206 may provide services for enabling Wi-Fi UEs to connect to an operator core network. In some embodiments, gateway 200 may coordinate multiple RANs using coordination module 208. If multiple RANs are coordinated, a database may include information from UEs on each of the multiple RANs. RAN configuration module 208 may include a DFS event and frequency hop sequence (FHS) database (DB) 208a, and may provide generation, retrieval, and profiling of DFS events as described herein.

In some embodiments, gateway 200 may also provide proxying, routing virtualization and RAN virtualization, including X2, S1, and S2a proxying, via module 210. In some embodiments, a downstream network interface 212 is provided for interfacing with the RANs, which may be a radio interface (e.g., LTE), and an upstream network interface 214 is provided for interfacing with the core network, which may be either a radio interface (e.g., LTE) or a wired interface (e.g., Ethernet).

In some embodiments, gateway 200 includes local evolved packet core (EPC) module 220, for authenticating users, storing and caching priority profile information, and performing other EPC-dependent functions when no backhaul link is available. Local EPC 220 may include local HSS 222, local MME 224, local SGW 226, and local PGW 228, as well as other modules. Local EPC 220 may incorporate these modules as software modules, processes, or containers. Local EPC 220 may alternatively incorporate these modules as a small number of monolithic software processes. Modules 206, 208, 210 and local EPC 220 may each run on processor 202 or on another processor, or may be located within another device.

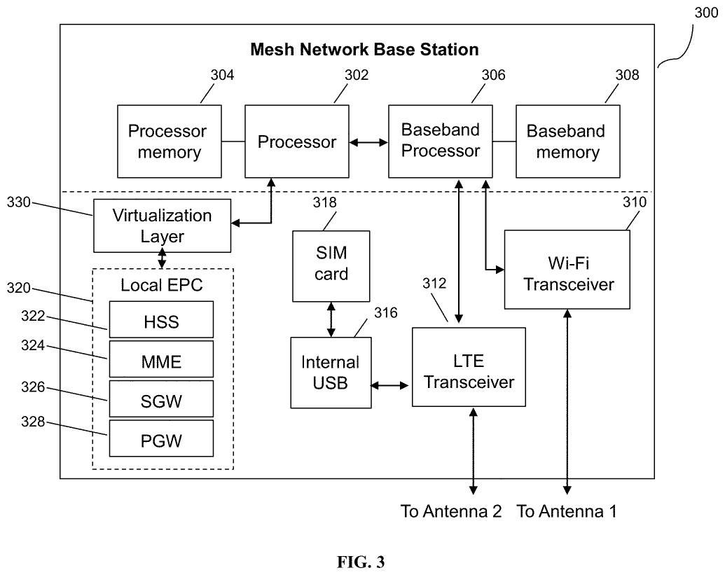

FIG. 3 is a schematic diagram of a mesh network base station, in accordance with some embodiments. Mesh network base station 300 may include processor 302, processor memory 304 in communication with the processor, baseband processor 306, and baseband processor memory 308 in communication with the baseband processor. Mesh network base station 300 may also include first radio transceiver 310, which may be a Wi-Fi transceiver, and second radio transceiver 312, which may be an LTE transceiver utilizing an LTE modem module connected to internal universal serial bus (USB) port 316 with subscriber information module card (SIM card) 318 coupled to USB port 314. In some embodiments, the second radio transceiver 314 itself may be coupled to USB port 316, and communications from the baseband processor may be passed through USB port 316.

Processor 302 and baseband processor 306 are in communication with one another. Processor 302 may perform routing functions, and may determine if/when a switch in network configuration is needed. Processor 302 may be responsible for initiating channel switch announcements (CSAs) and other Wi-Fi protocol messages as described herein, in conjunction with baseband processor 306. Baseband processor 306 may generate and receive radio signals for both radio transceivers 310 and 312, based on instructions from processor 302. In some embodiments, processors 302 and 306 may be on the same physical logic board. In other embodiments, they may be on separate logic boards.

SIM card 318 may provide information required for authenticating the simulated UE to the evolved packet core (EPC). When no access to an operator EPC is available, a local EPC on the enhanced eNodeB itself (not shown) may be used, or another local EPC on the network may be used. This information may be stored within the SIM card, and may include one or more of an international mobile equipment identity (IMEI), international mobile subscriber identity (IMSI), or other parameter needed to identify a UE.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 310 and 312, which may be Wi-Fi 802.11a/b/g/n/ac/ad/ah, Bluetooth, ZigBee, microwave (including line-of-sight microwave), satellite, or another wireless backhaul connection. Any of the wired and wireless connections may be used for either access or backhaul, according to identified network conditions and needs, and may be under the control of processor 302 for reconfiguration.

Other elements and/or modules may also be included, such as a home eNodeB, a local gateway (LGW), or another module. Additional radio amplifiers, radio transceivers and/or wired network connections may also be included.

Processor 302 may identify the appropriate network configuration, and may perform routing of packets from one network interface to another accordingly. Processor 302 may use memory 304, in particular to store a routing table to be used for routing packets. Baseband processor 306 may perform operations to generate the radio frequency signals for transmission or retransmission by both transceivers 310 and 312. Baseband processor 306 may also perform operations to decode signals received by transceivers 312 and 314. Baseband processor 306 may use memory 308 to perform these tasks.

When DFS events occur, it is possible that more than one radio ends up on the same channel due to radar event avoidance. If both radios in a communicative pair go to the same channel, this automatically causes the network to lose half its throughput as it gets reduced to a half-duplex mode. In some embodiments, a mechanism may ensure that the radios remain on different channels after DFS, preventing multiple base stations from using the same (duplicate) frequency after a DFS-triggered event.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for mesh link-aware dynamic frequency selection (DFS), comprising:
determining, in a mesh network having a plurality of mesh nodes and mesh links interconnecting the mesh nodes, a DFS event has been generated by a radar source interfering with a mesh link;
refraining from using the mesh link in order to prevent interfering with the DFS event; and
rerouting mesh messages which would have used the mesh link through other mesh nodes and links.

2. The method of claim 1 wherein the DFS event occurs in a 5 GHz band spectrum.

3. The method of claim 1 wherein the DFS event is at least on of maritime communications radars; weather radars; and military communications.

4. The method of claim 1 wherein when a mesh link goes down, other mesh links of the plurality of mesh links are subject to recalculation.

5. The method of claim 1 further comprising a mesh node sending a message to other mesh nodes alerting the other mesh nodes of to the DFS condition.

6. The method of claim 1 wherein the mesh network is one of an LTE-compatible network, an UMTS-compatible network, a 5G network, or networks for additional protocols that utilize radio frequency data transmission.

7. The method of claim 1 further comprising taking into account the occurrence of the DFS event for scheduling drops in backhaul.

8. A mesh network, comprising:
a plurality of mesh nodes;
a plurality of mesh node links interconnecting the plurality of mesh nodes;
wherein, when a notification is received that a DFS event has been generated by a radar source interfering with a mesh link, the mesh nodes using the mesh link refrain from using the mesh link in order to prevent interfering with the DFS event; and
reroute mesh messages which would have used the mesh link through other mesh nodes and links.

9. The mesh network of claim 8 wherein the DFS event occurs in a 5 GHz band spectrum.

10. The mesh network of claim 8 wherein the DFS event is at least on of maritime communications radars; weather radars; and military communications.

11. The mesh network of claim 8 wherein when a mesh link goes down, other mesh links of the plurality of mesh links are subject to recalculation.

12. The mesh network of claim 8 wherein a mesh node sends a message to other mesh nodes alerting the other mesh nodes of to the DFS condition.

13. The mesh network of claim 8 wherein the mesh network is one of an LTE-compatible network, an UMTS-compatible network, a 5G network, or networks for additional protocols that utilize radio frequency data transmission.

14. The mesh network of claim 8 wherein the occurrence of the DFS event is taken into account for scheduling drops in backhaul.

15. A non-transitory computer-readable medium comprising instructions which, when executed by a processor in a mesh gateway node, cause the mesh gateway node to perform steps comprising:
determining, in a mesh network having a plurality of mesh nodes and mesh links interconnecting the mesh nodes, a DFS event has been generated by a radar source interfering with a mesh link;
refraining from using the mesh link in order to prevent interfering with the DFS event; and
rerouting mesh messages which would have used the mesh link through other mesh nodes and links.

16. The non-transitory computer-readable medium of claim 15 further including instructions wherein the DFS event occurs in a 5 GHz band spectrum.

17. The non-transitory computer-readable medium of claim 15 further including instructions wherein the DFS event is at least on of maritime communications radars; weather radars; and military communications.

18. The non-transitory computer-readable medium of claim 15 further including instructions wherein when a mesh link goes down, other mesh links of the plurality of mesh links are subject to recalculation.

19. The non-transitory computer-readable medium of claim 15 further including instructions wherein a mesh node sends a message to other mesh nodes alerting the other mesh nodes of to the DFS condition.

20. The non-transitory computer-readable medium of claim 15 further including instructions wherein the mesh network is one of an LTE-compatible network, an UMTS-compatible network, a 5G network, or networks for additional protocols that utilize radio frequency data transmission.
